(19) United States
(12) Patent Application Publication
(10) Pub. No.: US 2009/0122538 A1
(43) Pub. Date: May 14, 2009

(54) LIGHTING ORNAMENT INCLUDING HOLOGRAPHIC ELEMENTS

(76) Inventor: Kuo-An PAN, Hong Kong (CN)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/938,380

(22) Filed: Nov. 12, 2007

(51) Int. Cl. F21V 33/00; F21S 13/14

(52) U.S. Cl. 362/235

(57) ABSTRACT

A decorative lighting apparatus comprising a structure, a plurality of light emitting elements, and a plurality of diffractive elements connected to the structure such that the plurality of light emitting elements is configured to emit light through the plurality of diffractive elements to a viewer to create multiple diffractive patterns.

### BACKGROUND OF THE INVENTION

1. Field of the Invention

The present invention related to decorative lighting apparatuses. More specifically the present invention relates to decorative lighting apparatuses including a plurality of diffractive elements.

2. Description of the Related Art

Decorative lighting apparatuses are often used as holiday decorations, especially for holidays such as Christmas and Halloween. However, related decorative lighting apparatuses typically include a light located above a reflective surface, which has a limited interest as the decoration looks very similar from different viewing angles. Accordingly, a more interesting decoration is desired, especially a decoration that presents a user with a number of diffractive images as well as changing as a viewer changes position with respect to the decoration.

### SUMMARY OF THE INVENTION

The present invention broadly comprises a decorative lighting apparatus including a structure, a plurality of light emitting elements, a structure to support the plurality of light emitting elements, and a plurality of diffractive elements. The plurality of diffractive elements is connected to the structure such that the plurality of light emitting elements illuminates the plurality of diffractive elements. The plurality of light emitting elements is configured to emit light through the plurality diffractive of elements to a viewer.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 shows a front view of a first embodiment of the present invention;

FIG. 2 shows a side view of a first embodiment of the present invention;

FIG. 3 shows a cutaway view of a the plurality of light emitting elements and the lighting structure;

FIG. 4 shows a perspective view of a snowman's hat;

FIG. 5 shows a perspective blow up of a connection mechanism for the body sections;

FIG. 6 shows to diffractive elements fastened together with a connector;

FIG. 7 shows a perspective blow up the side of a snowman arm and arm fastener;

FIG. 8 shows a perspective blow up of a connection between the lighting structure and the structure;

FIG. 9 shows a perspective blow up of bottom structure of the decorative lighting and how the lighting structure is attached to the structure;

FIG. 10 shows a perspective blow up of a the middle of a snowman;

FIG. 11 shows a perspective blow up of the head of a snowman; and

FIGS. 12a and 12b show a close-up illustration of a diffractive element and a lighting element;

FIG. 13 shows an alternate embodiments of the connectors for fastening together diffractive elements; and

FIG. 14 shows an alternate embodiment for fastening the lighting structure to the structure.

### DETAILED DESCRIPTION OF THE PREFERRED EMBODIMENTS

Referring now to the drawings, wherein like reference numerals designate identical or corresponding parts throughout the several views.

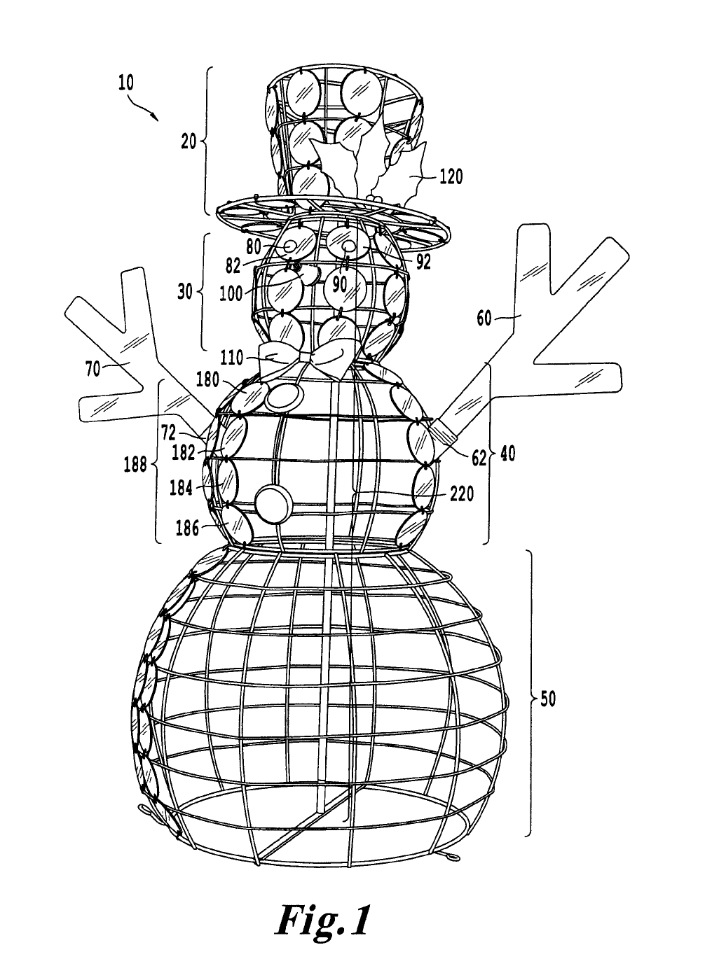

FIG. 1 shows a front view of a first embodiment. Decorative lighting apparatus 10 includes a hat section 20, body sections 30, 40, and 50. Attached on the outer surfaces of the hat and body sections, 20, 30, 40, and 50, respectively, are diffractive elements such as diffractive elements 180, 182, 184, and 186. Diffractive elements, such as diffractive elements 180, 182, 184 and 186, form strips such as diffractive strip 188. In addition to the shown diffractive strips, such as strip 188, the diffractive strips may cover the hat and body sections, 20, 30, 40, and 50, respectively. The diffractive elements may be transparent or translucent. As well, the diffractive elements may be of any color or shape. Typically, the diffractive elements will cover the majority of the decorative lighting apparatus 10.

The decorative lighting apparatus 10 also includes arm sections 60 and 70, which are connected to body section 40 by arm receptacles 62 and 72. Decorative eyes 80 and 90 are located on diffractive elements 82 and 92, which in turn are located on the front face of body section 30. Also located on the front face of body section 30 is a nose piece 100. At the juncture of body section 30 and body section 40 is bow tie 110. Adorning the hat section 20 is a decorative piece 120. Internal to decorative lighting apparatus 10 is lighting support section 220.

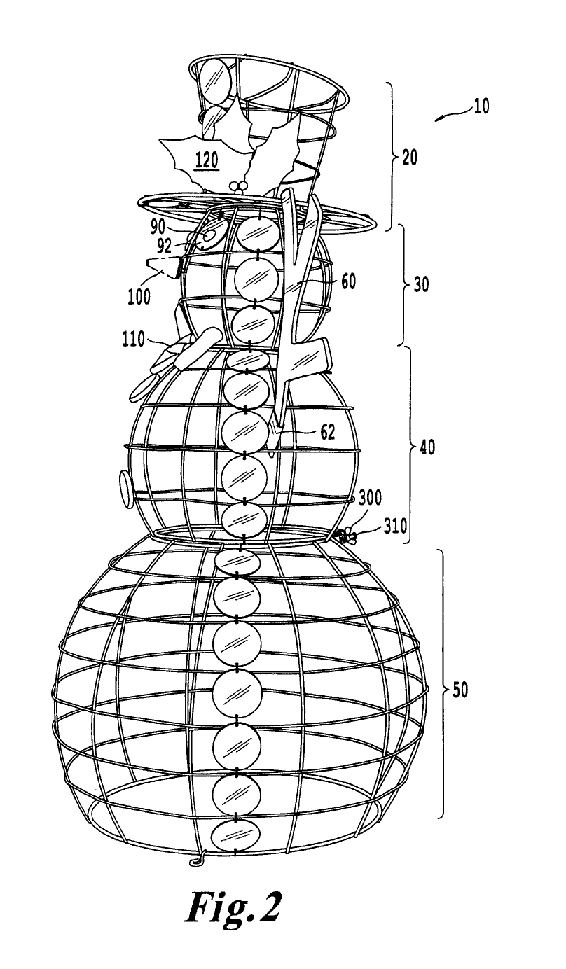

FIG. 2 illustrates a side view of decorative lighting apparatus 10. Also visible in FIG. 2 are wing nut 300 and bolt 310. Wing nut 300 and bolt 310 connect body sections 40 and 50. Although not visible in FIG. 2, body sections 30 and 40 as well as hat section 20 and body section 30 are similarly connected. However, any fastener known in the art may be used to connect hat section 20 and body sections 30, 40, and 50.

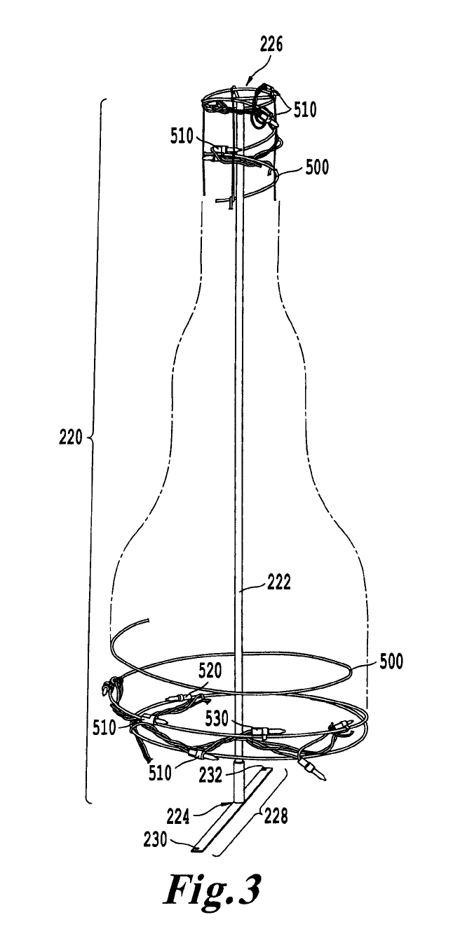

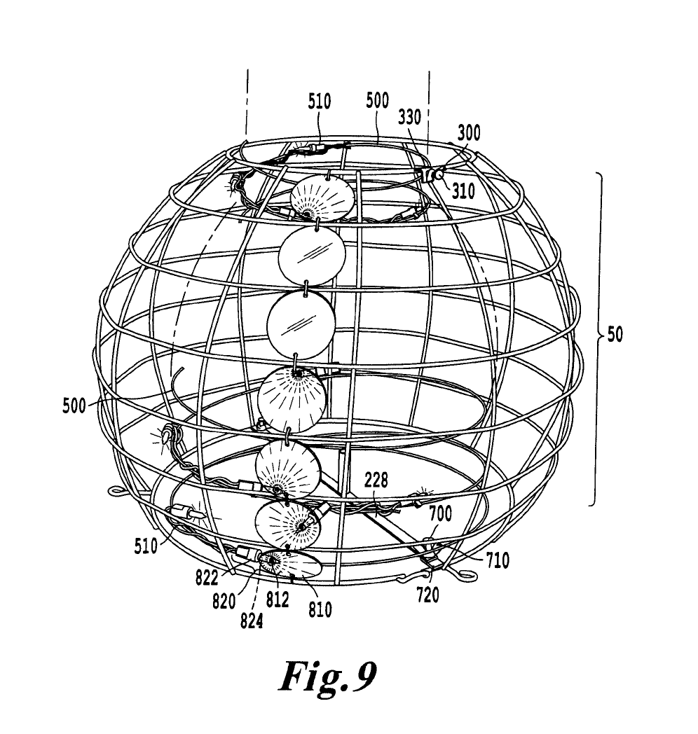

FIG. 3 shows the plurality of lighting elements 510 configured on lighting support section 220. Lighting support section 220 consists of vertical support member 222 and T section 228. T section 228 further comprises two holes, hole 230 and hole 232. The vertical support member has an upper end 226 and a lower end 224. Spiral member 500 forms a spiral with increasing circumference as it spirals down from upper end 226 to lower end 224. The plurality of lighting elements 510 is attached to spiral 500 and spiral 500 provides support for the plurality of lighting elements 510 as it spirals from end 226 to end 224. The plurality of lighting elements 510 may include a number of lighting elements such as lighting element 520 and lighting element 530. Any lighting element may be used to form the plurality of lighting elements. Similarly, any structure may form the support for the plurality of lighting elements. Lighting support section 220 is contained within the body section and hat section as shown in FIG. 1, and as shown in FIG. 9.

For example FIG. 14 illustrates an alternate embodiment where spiral number 500 is connected directly to hat section 20 by connector 600. As noted above, any structure may be used to support the plurality of lighting elements.

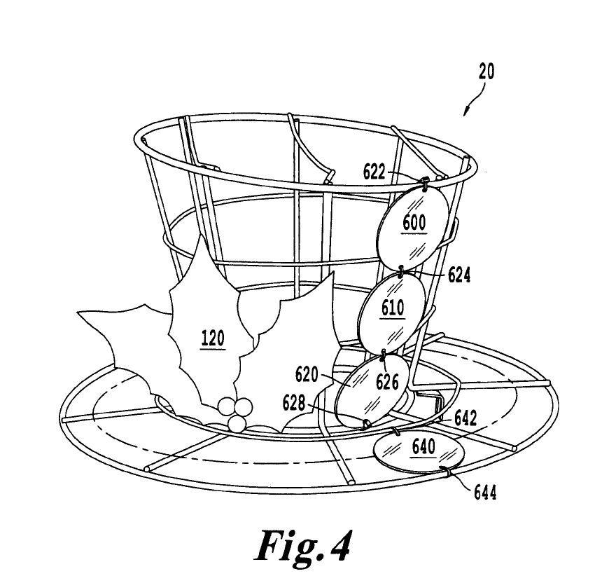

FIG. 4 illustrates an isolated view of the hat section 20. The hat has decorative element 120. The hat section is also covered by a plurality of diffractive elements, as exemplified by diffractive elements 600, 610, 620, 640. The diffractive elements 600, 610, and 620 are joined by connective elements 624 and 626. The diffractive elements 610, 620, and 600 form a diffractive strip which is attached to the hat section 20 by connecting elements 622 and 628. Likewise diffractive element 640 is connected to the hat by connection elements 642 and 644.

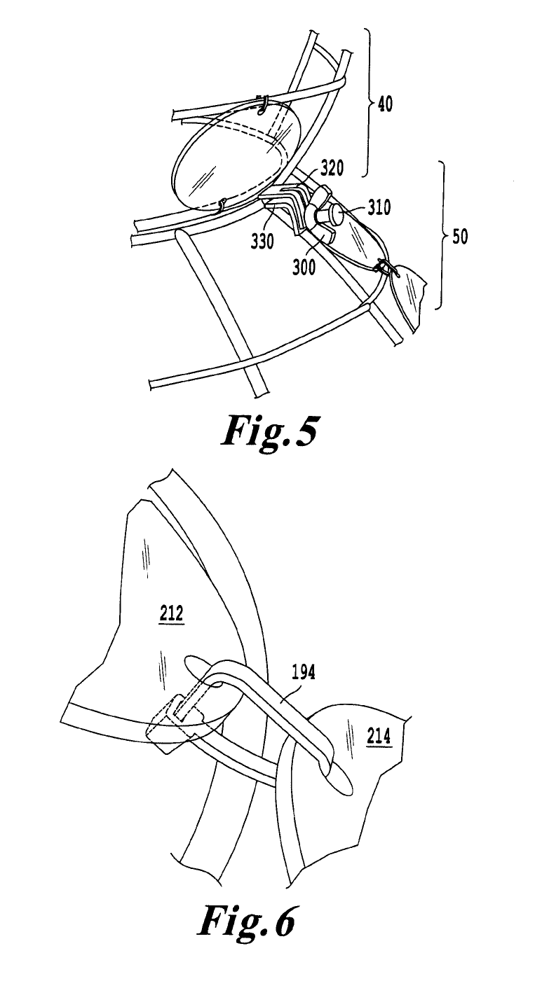

FIG. 5 is a close up view of how body sections 40 and 50 may be connected. Tab 320 is placed on tab 330. As placed in FIG. 5, the fork extension of tab 320 extends to either side of bolt 310. Wing nut 300 when tightened on bolt 310 holds tab 320 to tab 330 securing body section 40 and body section 50. Again, any fastener known in the art may be used to secure the hat and body sections.

FIG. 6 is an illustration of how the diffractive elements are connected by a connector. In FIG. 6, diffractive element 214 is connected to diffractive element 212 by connector 194. Connector 194 is, in this embodiment, a plastic connector with a fastener at one end. The other end is inserted into the fastener and secured thereon. The connector can be any connector known in the art.

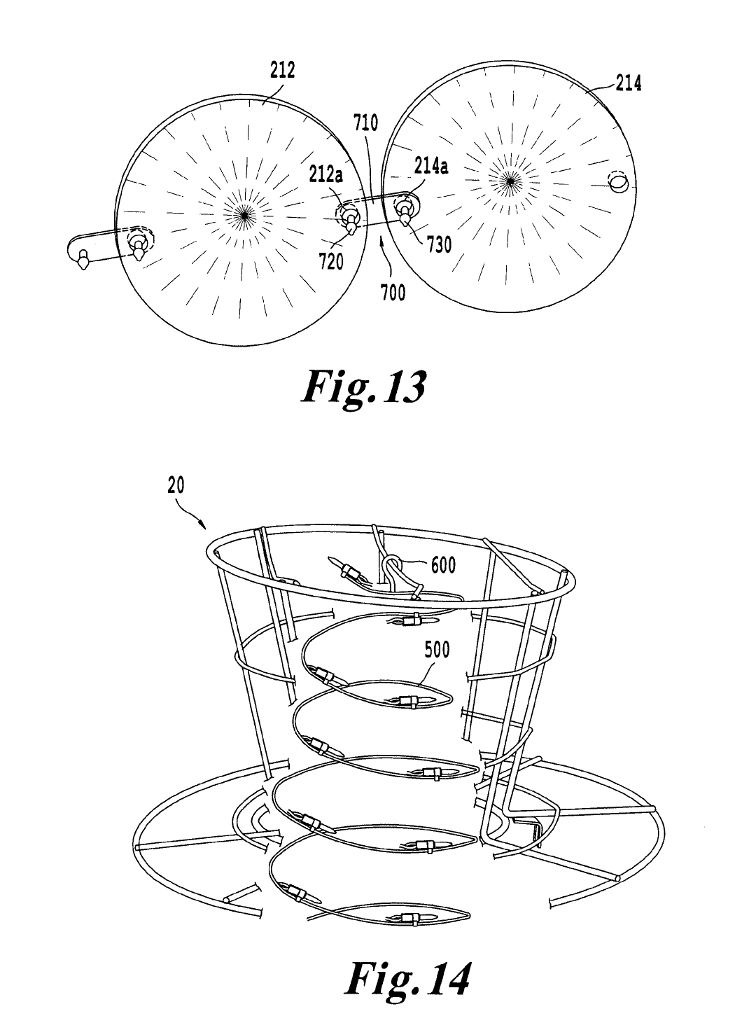

For example FIG. 13 shows an alternate embodiment for connecting diffractive elements. FIG. 13 shows the diffractive elements 212 and 214 connected by connector 700. Connector 700 and includes flat member 710 and projections 720 and 730. Projection 720 extends through a hole 212a in diffractive element 212 and projection 730 extends through a hole 214a in diffractive element 214.

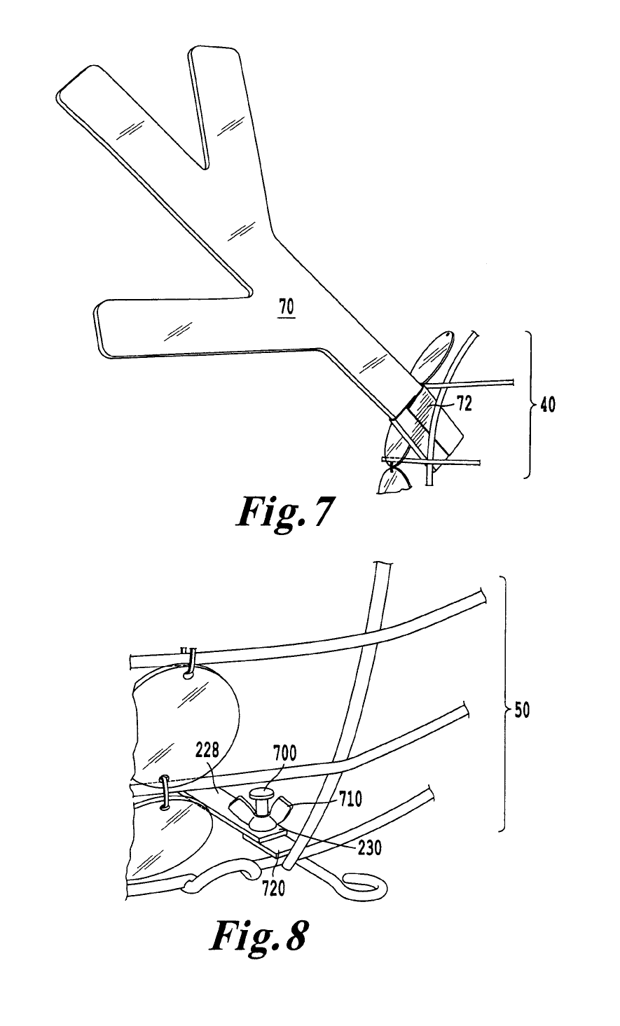

FIG. 7 illustrates how arm 70 fits in arm receptacle 72. As shown, receptacle 72 forms a socket type opening or sleeve in which arm 70 is placed. The fit of the sleeve on the arm and gravity hold arm 70 in place making arm 70 removably attached. Arm 60 and arm receptacle 62 function similarly. Of course, any method known in the art maybe used to secure the arms to the body sections.

FIG. 8 illustrates the connection between the lighting support structure 220 and body elements 20, 30, 40, and 50. As shown, hole 230 of T section 228 of lighting support structure 220 is positioned around bolt 700. Wing nut 710 secures T section 228 to tab 720 of body section 50. Hole 232 of T section 228 is similarly attached on the other side of body section 50.

FIG. 9 shows body section 50 with many of the plurality of diffractive elements removed to show interior detail. As shown illustrated in FIG. 8, T section 228 of lighting support section 220 is secured to body section 50. Wing nuts 710 and 730 secure T section 228 to tabs 720 and 750, respectively; further shown are tab 330 and wing nut 300 as well as bolt 310.

Also shown in FIG. 9 is a portion of lighting support section 220. This exemplifies how lighting support section 220 and the plurality of lighting elements 510 fit inside body sections 30, 40, 50 and hat section 20. As shown, the spiral 500 decreases in circumference as it extends upward towards the top of the body section. Configured on spiral 500 is the plurality of lighting elements 510.

FIG. 9 further illustrates how the plurality of lighting elements may be configured in a way such that they illuminate the plurality of diffractive elements, creating diffractive images. Of course, many such configurations inside the decorative lighting apparatus are possible. The plurality of lighting elements may be light bulbs, LEDs, or the like. Each diffractive element is capable of producing a different diffraction pattern based on its orientation respective to each of the plurality of illuminating elements 510. Also, the lighting support structure 220 upon which the plurality of lighting elements are affixed could be any type of structure. For example, in accordance with the present invention, the plurality of lighting elements could be attached to the hat and body sections directly.

The effect of plurality of lighting elements 510 on the plurality of diffractive elements is that, to a viewer observing the plurality of diffractive elements, is that each diffractive element, such as element 810, presents a different pattern, such as diffractive image 812. In totality, the decorative lighting structure 10 is illuminated by the plurality of lighting elements 510 creating a plurality of different diffractive patterns on the plurality of diffractive elements.

When the light passes through the plurality of diffractive elements, a visible diffraction pattern is created, providing a pleasing visual appearance to an observer. Further, as the angle of incidence between each of the plurality of diffractive elements is different, a plurality of different diffractions is provided to the observer. When the observer changes position with respect to the decorative lighting apparatus 10, the diffraction patterns continually change, creating an interesting visual effect. If the diffractive elements cover the decorative lighting apparatus 10, the plurality of diffraction patterns can be viewed from any side of the decorative lighting apparatus 10.

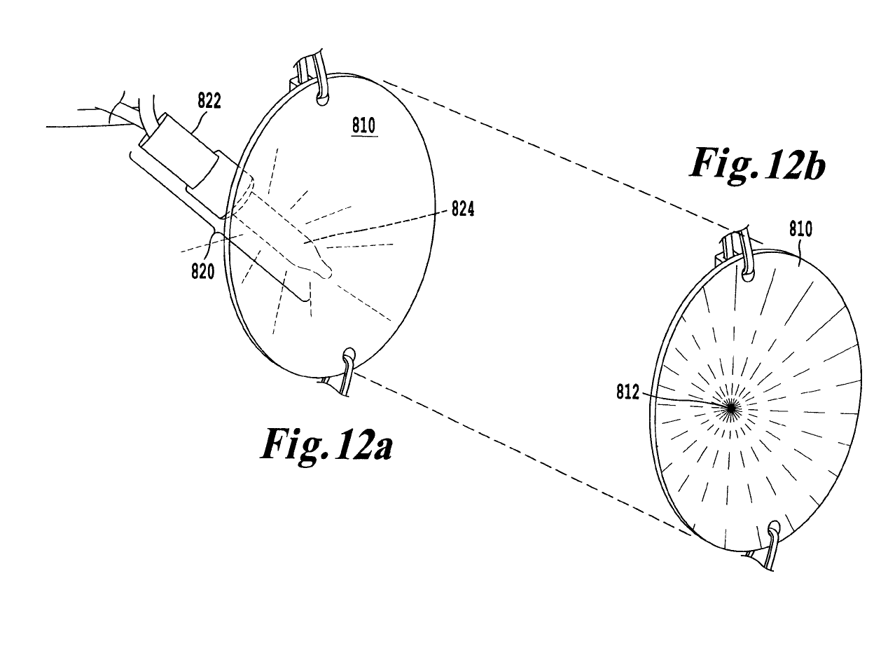

For example, lighting element 820, composed in this embodiment of light bulb 824 and socket 822, illuminates diffractive element 810 creating diffractive pattern 812. A close up of this may be seen in FIG. 12.

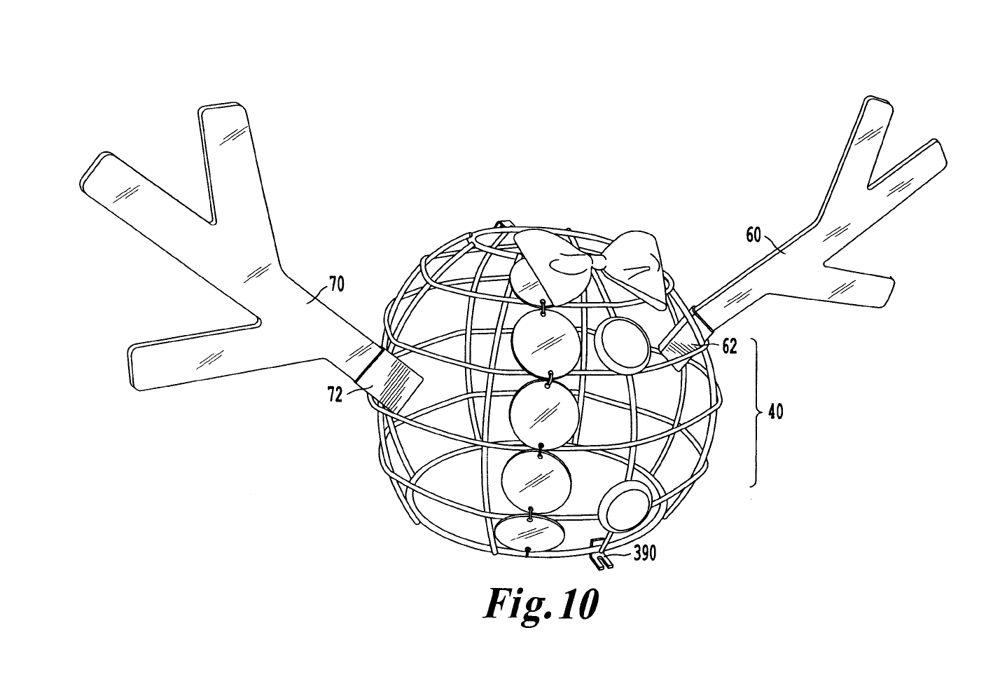

FIG. 10 illustrates body section 40 with some of the plurality of diffractive elements removed to show inner detail. Also shown in FIG. 10 is tab 390. In addition to tab 320, tab 390 secures body section 40 to body section 50. Specifically, the prongs of tab 390 fit around one of the latitudinal elements that form body section 50. This secures the front face of body section 40 to the front face of body section 50. FIG. 5 illustrates how tab 320 is used to secure the back face of body sections 40 and 50. Body sections 30 and 40 as well as hat section 20 and body section 30 are secured similarly.

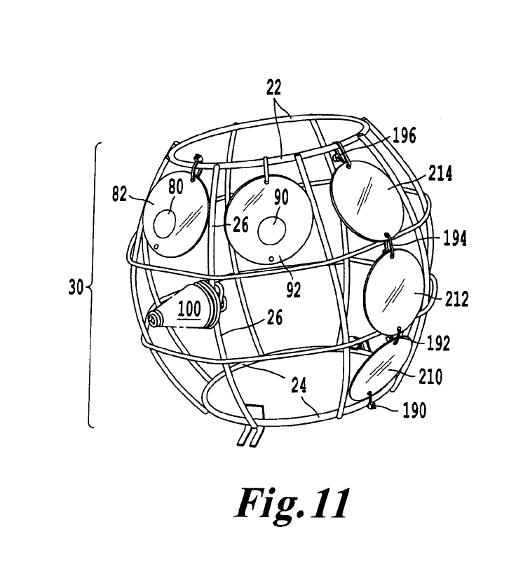

FIG. 11 is an illustration of body section 30 with some of the plurality of diffractive elements removed to show detail. In particular FIG. 11 shows how each of the plurality of diffractive elements may be attached to each other to form a strip of diffractive elements. Diffractive element 210 is connected to diffractive element 212 by connector 192. Similarly diffractive elements 212 and 214 are connected by connector 194. The strip composed of diffractive elements 210, 212, and 214 and connectors 192 and 194 is then attached to the top ring 22 and bottom ring 24 of body section 20 by connectors 196 and 190.

Also shown in FIG. 11 is nose 100. Nose 100 is composed of a coil to form a conical structure. Nose 100 is attached to body section 30 by wrapping the end of the coil around latitudinal element 26 of body section 30.

FIG. 12a shows a close-up illustration of a lighting element and a diffractive element and FIG. 12b shows an image that may be created on a diffractive element when illuminated. As in FIG. 9, lighting element 822 illuminates diffractive element 810 to create diffractive image 812. In FIG. 12a, in the portion of the figure with diffractive element 810, the relationship between the lighting element and the diffractive element is shown. In FIG. 12b the diffractive image 812 made by illuminating diffractive element 810 is shown. Of course, depending on the arrangement of the lighting elements, the diffractive image can occur in different places on the diffractive element. As well, also depending on the orientation of the plurality of lighting elements, more than one image may appear on each of the plurality of diffractive elements.

FIGS. 1-14 show an embodiment of the invention where the decorative lighting appears as a snowman but angels, Santa Clauses, Christmas trees, drums, penguins, polar bears, snowflakes, pumpkins, trains, candy canes, starts, and igloos are also possible. These alternative structures could be made up of any number of sub sections or substructures. These modifications are within the scope of the invention as claimed.

Obviously, numerous modifications and variations of the present invention are possible in light of the above teachings. It is therefore to be understood that within the scope of the appended claims, the invention may be practiced otherwise than as specifically described herein.

1. A decorative lighting apparatus comprising:
a structure;
a plurality of light emitting elements; and
a plurality of diffractive elements connected to said structure such that said plurality of light emitting elements is configured to emit light through said plurality of diffractive elements to a viewer to create a plurality of diffractive patterns.

2. The decorative lighting apparatus recited in claim 1, wherein said structure is in a shape of a snowman, the snowman comprising:
three body sections;
a hat, and
arms.

3. The decorative lighting apparatus recited in claim 1, further comprising:
a lighting support structure, wherein the lighting support structure is configured to support said plurality of light emitting elements and is located inside said structure.

4. The decorative lighting apparatus recited in claim 3, wherein said lighting support structure is a spiral and the plurality of light emitting elements is connected along said spiral.

5. The decorative lighting apparatus in claim 1, wherein said plurality of diffractive elements covers a majority of each external surface of said structure.

6. The decorative lighting apparatus recited in claim 1, wherein at least one of said plurality of diffractive elements is transparent.

7. The decorative lighting apparatus recited in claim 1, wherein at least one of said plurality of light emitting elements is a light bulb.

8. The decorative lighting apparatus of claim 1, wherein at least one of said plurality of light emitting elements is a light emitting diode.

9. The decorative lighting apparatus recited in claim 1, wherein said structure has a shape of a hat.

10. The decorative lighting apparatus recited in claim 1 wherein said plurality of diffractive elements is located on all faces of said structure.

11. The decorative lighting apparatus recited in claim 1, wherein at least one of said plurality of diffractive elements is round.

12. The decorative lighting apparatus recited in claim 3, wherein said lighting support structure is directly connected to said structure.

13. The decorative lighting apparatus recited in claim 1, wherein at least two of said plurality of diffractive elements are connected to each other using a connector, said connector including a substantially flat member and two projections extending from the flat member, wherein one projection extends through a hole in each of said two of said plurality of diffractive elements.

14. A decorative lighting apparatus comprising:
a structure;
a plurality of means for emitting light;
a plurality of means for diffracting light connected to said structure such that said plurality of means for emitting light illuminates said means for diffracting light to create a plurality of diffraction patterns.

15. The decorative lighting apparatus recited in claim 14, wherein said structure is in a shape of a snowman, the snowman comprising:
three body sections;
a hat, and
arms.

16. The decorative lighting apparatus recited in claim 14, further comprising:
a lighting support structure, wherein said lighting support structure is configured to support said plurality of means for emitting light and said lighting support structure is located inside said structure.

17. The decorative lighting apparatus recited in claim 16, wherein said lighting support structure is a spiral and the plurality of means for emitting light is connected along the spiral.

18. The decorative lighting apparatus in claim 14, wherein said plurality of means for diffracting light covers a majority of each external surface of said structure.

19. The decorative lighting apparatus recited in claim 14, wherein at least one of said plurality of means for diffracting light is transparent.

20. The decorative lighting apparatus recited in claim 14, wherein at least one of said plurality of means for emitting light is a light bulb.

21. The decorative lighting apparatus of claim 14, wherein at least one of said plurality of means for emitting light is a light emitting diode.

22. The decorative lighting apparatus recited in claim 14, wherein said structure has a shape of a hat.

23. The decorative lighting apparatus recited in claim 14, wherein said plurality of means for diffracting light is located on all external faces of said structure.

24. The decorative lighting apparatus recited in claim 14, wherein at least one of said means for diffracting light is round.

25. The decorative lighting apparatus recited in claim 16, wherein said lighting support structure is directly connected to said structure.

26. The decorative lighting apparatus recited in claim 14, wherein at least two of said means for diffracting light are connected to each other using a connector, said connector including a substantially flat member and two projections extending from the flat member, wherein one projection extends through a hole in each of said two of said means for diffracting light.
